(19) United States
(12) Patent Application Publication
(10) Pub. No.: US 2006/0072057 A1
(43) Pub. Date: Apr. 6, 2006

(54) Optical film and image viewing display

(75) Inventors: Shuuji Yano, Osaka (JP); Kenji Yoda, Osaka (JP); Mie Nakata, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/237,953

(22) Filed: Sep. 29, 2005

(30) Foreign Application Priority Data
Oct. 1, 2004 (JP) 2004-290182

(51) Int. Cl. G02F 1/1335

(52) U.S. Cl. 349/117; 349/141

(57) ABSTRACT

An optical film of the invention comprises a polarizing plate obtained by laminating a transparent protective film on at least one surface of a polarizer and a retardation film laminated on one surface of the polarizing plate so that the absorption axis of the polarizing plate and the slow axis of the retardation film are perpendicular to or in parallel with each other, wherein the retardation film satisfies a relation of nx>nz>ny, and the transparent protective film is disposed at least on the retardation film side and is a cellulose-based film with retardation in the thickness direction, which is expressed by (Rth)=(nx−nz)×d, in the range of 0 to 10 nm, where in each of the films, a refractive index of a slow axis direction, a refractive index of a fast axis direction and a refractive index in the thickness direction at a wavelength of 590 nm are represented by nx, ny and nz, respectively, that a film thickness is represented d (nm) and that the slow axis direction is defined as a direction in which a refractive index in a film plane is maximized. The optical film is useful for image viewing display to provide a high contrast ratio over a wide range and to realize a better view.

### FIELD OF THE INVENTION

This invention relates to an optical film obtained by laminating a polarizing plate and a retardation film. The optical film of the invention is suited for use in an image viewing display such as a liquid crystal display, PDP, CRT. Particularly, the optical film of the invention is suited for use in a liquid crystal display driving in IPS mode.

### BACKGROUNG ART

Conventionally, as a liquid crystal display, there has been used a liquid crystal display in TN mode in which a liquid crystal having a positive dielectric anisotropy is twisted aligned between substrates mutually facing to each other. However, in TN mode, when black view is displayed, optical leakage resulting from birefringence caused by liquid crystal molecule near a substrate made it difficult to obtain perfect display of black color owing to driving characteristics thereof. On the other hand, in a liquid crystal display in IPS mode, since liquid crystal molecule has almost parallel and homogeneous alignment to a substrate surface in non-driven state, light passes through the liquid crystal layer, without giving almost any change to a polarization plane, and as a result, arrangement of polarizing plates on upper and lower sides of the substrate enables almost perfect black view in non-driven state.

Although almost perfect black view may be realized in normal direction to a panel in IPS mode, when a panel is observed in oblique direction, inevitable optical leakage occurs caused by characteristics of a polarizing plate in a direction shifted from an optical axis of the polarizing plates placed on upper and lower sides of the liquid crystal cell, as a result, leading to a problem of narrowing of a viewing angle.

In order to solve this problem, there has been used a polarizing plate that is compensated a geometric axis shift of a polarizing plate generated when observed in an oblique direction by a retardation film (see, for example, JP-A No. 4-305602 and JP-A No. 4-371903).The retardation film has been used as a protective film for a polarizer in the polarizing plate described in the published Patent Applications. With the retardation film described in the published Patent Applications, however, it is difficult to achieve a sufficiently wide viewing angle in IPS mode liquid crystal display.

In a polarizing plate described in JP-A No. 4-305602, a retardation film is used as a protective film of a polarizer. The polarizing plate, however, acquires a good viewing angle characteristic in an ordinary environment of usage, whereas the protective film laminated directly thereon also deforms due to a change in dimension of the polarizer at a high temperature and high humidity. Hence, a problem has arisen that a retardation value of a retardation film used as a protective film is deviated from a desired value, thereby disabling the effect to be stably retained.

On the other hand, in JP-A No. 4-371903, a retardation film is laminated on a polarizing plate to which a triacetyl cellulose film (TAC film) that is generally used as a protective film is applied. In this case, since a stress does not act directly on the retardation film, a retardation value of the retardation film is stable. However, since a retardation value that cannot be neglected exists in a TAC film, difficulty is encountered in design of a retardation film compensating the axial deviation. Coloring occurs under an influence of retardation.

### SUMMARY OF THE INVENTION

The invention is directed to an optical film comprising a polarizing plate and an retardation film and it is an object of the invention to provide an optical film having a high contrast ratio over a wide range and capable of realizing a better view in a case where the optical film is applied to a image viewing display.

It is another object of the invention to provide a liquid crystal display, particularly driving in IPS mode, using the optical film and being capable of realizing a better view having a high contrast ratio over a wide range.

The inventors have conducted serious studies in order to solve the above problem and as a result of the studies, have found an optical film shown below, which has led to completion of the invention.

That is, the present invention related to an optical film comprising a polarizing plate obtained by laminating a transparent protective film on at least one surface of a polarizer and a retardation film laminated on one surface of the polarizing plate so that the absorption axis of the polarizing plate and the slow axis of the retardation film are perpendicular to or in parallel with each other, wherein
the retardation film satisfies a relation of nx>nz>ny, and

the transparent protective film is disposed at least on the retardation film side and is a cellulose-based film with retardation in the thickness direction, which is expressed by (Rth)=(nx−nz)×d, in the range of 0 to 10 nm.

In each of the films, a refractive index of a slow axis direction, a refractive index of a fast axis direction and a refractive index in the thickness direction at a wavelength of 590 nm are represented by nx, ny and nz, respectively, that a film thickness is represented d (nm) and that the slow axis direction is defined as a direction in which a refractive index in a film plane is maximized.

In an optical film of the invention, an polarizer is used in the form of a polarizing plate obtained by laminating a transparent protective film thereon from the viewpoint of heat resistance, moisture resistance, and weather resistance and a cellulose-based film is used as a transparent protective film on the side on which a retardation film is laminated. Usually, the retardation film side is the liquid crystal cell side. Since a retardation value of the transparent protective film laminated on a surface of a polarizer on the side closer to the liquid crystal cell exerts an influence on a viewing angle characteristic of a liquid crystal display, it is desired that the transparent protective film has a small retardation value. A cellulose-based film used as a transparent protective film of a polarizing plate generally has a retardation value in the thickness direction (Rth) that is large and in the range of about 40 to 60 nm, while a cellulose-based film of the invention has a retardation value in the thickness direction (Rth) that is small and in the range of from 0 to 10 nm. With a small residual retardation adopted, not only is design of a retardation film to be laminated easier, but an optical film high in compensation effect by the retardation film can be also attained. Thereby, a display which has a high contrast ratio over a wide range and therefore, is easy to be viewed can be realized.

A retardation value in the thickness direction (Rth) of a cellulose-based film, which is the transparent protective film, is ordinarily in the range of from 0 to 10 nm, preferably in the range of from 0 to 6 nm and more preferably in the range of from 0 to 3 nm. Note that a cellulose-based film of the invention has an in-plane retardation (Re) that is smaller than a film that is generally used. An in-plane retardation (Re) is preferably in the range of from 0 to 2 nm and more preferably in the range of from 0 to 1 nm.

In the above optical film, the retardation film preferably satisfies that an Nz value, which is expressed by Nz=(nx−nz)/(nx−ny), is in the range of from 0.4 to 0.6 and an in-plane retardation, which is expressed by (Re)=(nx−ny)×d, is preferably in the range of from 200 to 350 nm.

A retardation film satisfying the Nz value and the in-plane retardation (Re) is preferable, in a case where an optical film of the invention is used and a polarizing plate is placed in the crossed-Nichols positional relation, since light leakage in a direction deviated from the optical axis is prevented by the specific retardation film. Especially in a liquid crystal display in the IPS mode, the retardation film has a function to compensate reduction in contrast in a direction oblique relative to a liquid crystal layer. Since an optical film of the invention, as described above, uses a cellulose-based film very small in retardation in the thickness direction (Rth) as a transparent protective film, a compensation effect of the retardation film is especially high.

An Nz value is preferably 0.45 or more and more preferably 0.48 or more in order to enhance a compensation effect. On the other hand, an Nz value is preferably 0.55 or less and more preferably 0.52 or less. An in-plane retardation Re is preferably 230 nm or more and more preferably 250 nm or more in order to enhance a compensation effect. On the other hand, an in-plane retardation Re is preferably 300 nm or less and more preferably 280 nm or less. No specific limitation is placed on a thickness d of a retardation film but a thickness thereof is usually in the range of about 40 to 100 μm and preferably in the range of from 50 to 70 μm.

And the present invention related to an image viewing display comprising the above optical film.

Further, the present invention related to a liquid crystal display in the IPS mode, comprising a liquid crystal cell, the above optical film disposed on a first cell substrate of the viewing side so that the retardation film faces the first cell substrate side, and a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a second cell substrate on the other side relative to the viewing side so that the transparent protective film faces the second cell substrate side, wherein, in a state where no voltage is applied, an extraordinary ray refractive index direction of a liquid crystal material in the liquid crystal cell and the absorption axis of the polarizing plate are in parallel with each other.

Further, the present invention related to a liquid crystal display in the IPS mode, comprising a liquid crystal cell,

a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a first cell substrate on the viewing side so that the transparent protective film faces the first cell substrate side, and

the above optical film is disposed on the second cell substrate on the other side relative to the viewing side so that the retardation film in the optical film faces the second cell substrate side,

wherein, in a state where no voltage is applied, an extraordinary ray refractive index direction of a liquid crystal material in the liquid crystal cell and the absorption axis of the optical film are perpendicular to each other.

A liquid crystal display in the IPS mode is preferable as an image viewing display of the invention. By placing an optical film of the invention, as described above, on one of both surfaces of an liquid crystal cell in the IPS mode, and, on the other side of the liquid crystal cell, also placing a polarizing plate obtained by laminating a cellulose-based film small in retardation in the thickness direction (Rth) on at least one surface of a polarizer as a transparent protective film, light leakage in black viewing, which has arisen conventionally in a liquid crystal display in the IPS mode, can be reduced. Such a liquid crystal display in the IPS mode has a high contrast ratio in all of the directions and can show a display easy to be viewed in a wide viewing angle. Note that a cellulose-based film (a transparent protective film) used on a polarizing plate placed on the other side of the liquid crystal cell from the optical film has preferably retardation in the thickness direction (Rth) and an in-plane retardation (Re) similar to those as described above.

### BRIEF DESCRIPTION OF THE DRAWING

FIG. 1 is an example sectional view of an optical film of the invention.

FIG. 2 is a conceptual view of a liquid crystal display of the invention.

FIG. 3 is a conceptual view of a liquid crystal display of the invention.

### DESCRIPTION OF THE PREFERRED EXAMPLES

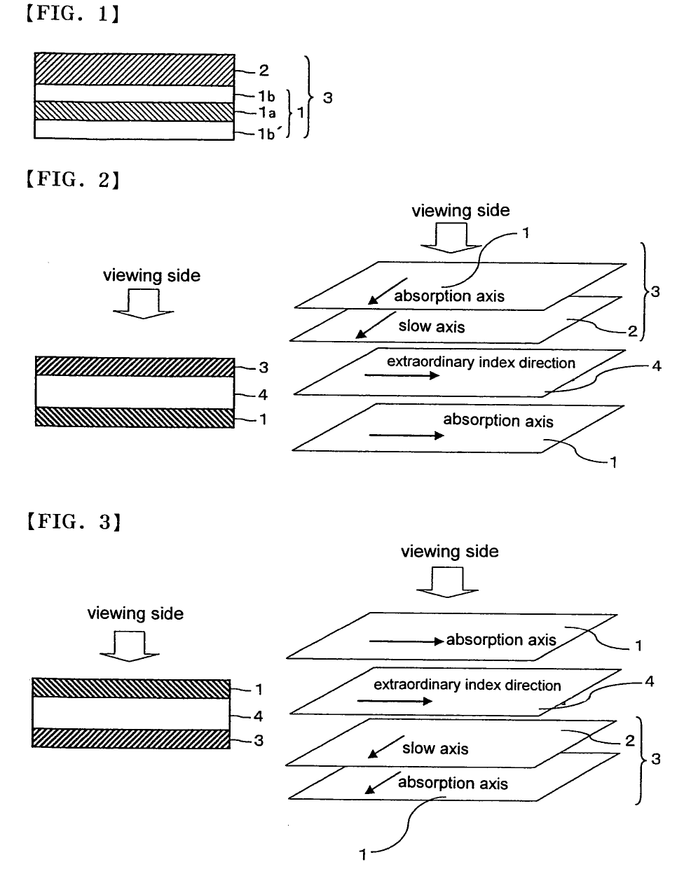

Description will be given of an optical film and an image viewing display of the invention below with reference to the accompanying drawing. A optical film 3 of the invention comprises a retardation film 2 placed on one surface of a polarizing plate 1 having a transparent protective film on at least one surface of a polarizer 1a, as shown in FIG. 1. A transparent protective film (1b) is placed at least on the retardation film 2 side of the polarizer 1a. The transparent protective film (1b) is a cellulose-based film small in retardation in the thickness direction (Rth). In FIG. 1, exemplified a case where the polarizer 1a has the transparent protective films (1b and 1b′) on both surfaces of the polarizer 1a. Note that no specific limitation is imposed on the transparent protective film (1b′) on the other side of the polarizer 1a opposite to the retardation film 2 and the transparent protective film (1b′) may be either a cellulose-based film having a small retardation in the thickness direction (Rth) similar to that in the transparent protective film (1b) or a different transparent protective film. The polarizing plate 1 and the retardation film 2 are laminated so that the absorption axis of the polarizing plate 1 and the slow axis of the retardation film 2 are perpendicular to or in parallel with each other. The absorption axis of the polarizing plate 1 and the slow axis of the retardation film 2 are preferably laminated so as to be in parallel with each other in consideration of a continuous adhesion step in lamination.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type orientation films, such as dehydrated polyvinyl alcohol and dehydrochlorinated polyvinyl chloride, etc. may be mentioned. In these, a polyvinyl alcohol type film on which dichromatic materials such as iodine is absorbed is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A transparent protective film of a polarizer used on the side thereof on which a retardation film is laminated is a cellulose-based film having retardation in the thickness direction (Rth) in the range of from 0 to 10 nm. Examples of cellulose-based film materials include fatty acid substituted cellulose-based polymers such as diacetyl cellulose, triacetyl cellulose and others.

A triacetyl cellulose, which has been generally employed, has retardation in the thickness direction (Rth) of 40 nm at a thickness of 40 μm, which does not satisfy the requirement for retardation in the thickness direction (Rth). In the invention, a cellulose-based film is properly processed on retardation in the thickness direction (Rth) to thereby control retardation in the thickness direction (Rth) of the cellulose-based film to a smaller value. No specific limitation is imposed on processing means and, for example, the following means can control retardation in the thickness direction (Rth) of a cellulose-based film to a smaller value. There are exemplified a method in which a substrate, such as polyethylene terephthalate, polypropylene or stainless on which a solvent such as cyclopetanone or methyl ethyl ketone is coated is adhered onto a commonly used cellulose-based film, the composite film is heated and dried at a temperature of about 80 to 150° C. for a time of about 3 to 10 min and thereafter, a substrate film is peeled off; and a method in which a solution obtained by dissolving norbornene-based resin or acrylic-based resin into a solvent such as cyclopentanone, or methyl ethyl ketone is coated on a commonly used cellulose-based film, the wet coat is heated and dried at a temperature of about 80 to 150° C. for a time of about 3 to 10 min and thereafter, a coat film is peeled off. With such processing applied, retardation in the thickness direction (Rth) can be controlled to a smaller value.

A fatty acid-substituted cellulose-based polymer in which a degree of substitution with a fatty acid is controlled can be used as a cellulose-based film with retardation in the thickness direction (Rth) in the range of 0 to 10 nm. A commonly used triacetyl cellulose has a degree of substitution with acetic acid of about 2.8, while, by using triacetyl cellulose with a degree of substitution with acetic acid controlled in the range of from 1.8 to 2.7 and with propionic acid controlled in the range of from 0.1 to 1, retardation in the thickness direction (Rth) is controlled to a smaller value. Besides, by adding a plasticizer such as dibutyl phthalate, p-toluene sulfoanilide or acetyl triethyl citrate to a fatty acid-substituted cellulose-based polymer, retardation in the thickness direction (Rth) can be controlled to a smaller value. An amount of a plasticizer is preferably about 40 parts by weight or less, more preferably in the range of from 1 to 20 parts by weight and further more preferably in the range of from 1 to 15 parts by weight relative to 100 parts by weight of a fatty acid substituted cellulose-based polymer. Besides, by combining the techniques, retardation in the thickness direction (Rth) can be controlled to a smaller value.

Note that no specific limitation is imposed on a thickness of a cellulose-based film with retardation in the thickness direction (Rth) in the range of from 0 to 10 nm and a thickness thereof is usually in the range of about 20 to 200 μm, preferably in the range of from 30 to 100 μm and more preferably in the range of from 35 to 95 μm in order to not only maintain a film strength but also control retardation in the thickness direction (Rth) within the range.

No specific limitation is imposed on a transparent protective film on the other side of a polarizer opposite to the side on which a retardation film is laminated and a transparent protective film on the other side may be either a cellulose-based film small in retardation in the thickness direction (Rth) or a transparent protective film other than the above described films. This is because a transparent protective film in which optimization of a retardation value is desired is a transparent protective film on the side of a polarizer closer to a liquid crystal cell and a transparent protective film laminated on a surface of the polarizer on the side thereof farther from the liquid crystal cell does not alter an optical characteristic of a liquid crystal display.

Materials forming a transparent protective film other than those described above are preferably materials excellent in transparency, mechanical strength, thermal stability, moisture barrier and isotropy and the like. Examples of materials forming such a transparent protective film include: for example, polyester type polymers, such as polyethylene terephthalate and polyethylenenaphthalate; cellulose type polymers, such as diacetyl cellulose and triacetyl cellulose (provided that retardation in the thickness direction (Rth) is out of the above described range); acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned. In addition, a film comprising resins of heat curing type or ultraviolet curing type, such as acrylics type, urethane type, acrylics urethane type and epoxy type and silicone type may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used. Since the films are less in retardation and less in photoelastic coefficient, faults such as unevenness due to a strain in a polarizing plate can be removed and besides, since they are less in moisture permeability, they are excellent in durability under humidified environment.

A thickness of a transparent protective film can be properly determined, but a thickness thereof is generally selected as a value of the order in the range of from 1 to 500 μm in light of operability such as a strength and handlability and being a thin layer. More preferable is in the range of from 5 to 200 μm and further more preferable is in the range of from 1 to 500 μm. A thickness thereof in the ranges protects a polarizer mechanically, and the polarizer is not shrunk even under exposure to an environment at a high temperature and high humidity, thereby enabling a stable optical characteristic to be retained.

As the opposite side of the polarizing-adhering surface above-mentioned protective film, a film with a hard coat layer and various processing aiming for antireflection, sticking prevention and diffusion or anti glare may be used.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight part to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Isocyanate based adhesives, polyvinyl alcohol based adhesives, gelatin based adhesives, vinyl based latex based, aqueous polyester based adhesives, and etc. may be used for adhesion processing for the above-mentioned polarizers and transparent protective films.

As the retardation films, a birefringent film made from a polymer film; an alignment film made from a liquid crystal polymer and others, are exemplified. The retardation films satisfying the above Nz value and in-plane retardation value Re are preferable.

Among polymers are, for example: polycarbonate; polyolefins, such as and polypropylene; polyesters, such as polyethylene terephthalate and polyethylenenaphthalate; cycloaliphatic polyolefins, such as poly norbornene etc.; polyvinyl alcohols; polyvinyl butyrals; polymethyl vinyl ethers; poly hydroxyethyl acrylates; hydroxyethyl celluloses; hydroxypropyl celluloses; methylcelluloses; polyarylates; polysulfones; polyether sulfones; polyphenylene sulfides; polyphenylene oxides; poly aryl sulfones; polyvinyl alcohols; polyamides; polyimides; polyvinyl chlorides; cellulose based polymers; or various kinds of binary copolymers; ternary copolymers; and graft copolymers of the above-mentioned polymers; or their blended materials. A retardation film may be obtained by adjusting a refractive index in a thickness direction using a method in which a polymer film is biaxially stretched in a planar direction, or a method in which a high polymer film is uniaxially or biaxially stretched in a planar direction, and also stretched in a thickness direction etc. And a retardation film may be obtained using, for example, a method in which a heat shrinking film is adhered to a polymer film, and then the combined film is stretched and/or shrunken under a condition of being influenced by a shrinkage force to obtain tilted orientation.

The shrinkable film is prepared and by adhered on one surface or both surfaces of a polymer film to heat-stretch the composite film. A polymer film with a thickness of 10 to 500 μm is preferably used, but a thickness thereof is preferably selected according to a retardation value of a design.

A shrinkable film is used in order to impart a shrinkage force in the direction perpendicular to the stretch direction in heat stretching. To be concrete, examples thereof include: a biaxially stretched film, a uniaxially stretched film and others. Materials of shrinkable films include: polyester, polystyrene, polyethylene, polypropylene, polyvinyl chloride, polyvinylidene chloride and others, to which a shrinkable film is not limited. A biaxially stretched polypropylene film is excellent in uniformity in shrinkage and heat resistance, and therefore, preferably used.

A shrinkable film has preferably a shrinkability in the machine direction S (MD) at 140° C. relative to a polymer film on which a shrinkable film or films are laminated in the range of 4 to 20% and a shrinkability in the transverse direction S(TD) in the range of from 4 to 30%. More preferable S(MD) is in the range of from 5 to 10% and more preferable S(TD) is in the range of 7 to 25%. Especially preferable S(MD) is in the range of from 6 to 8% and especially preferable S(TD) is in the range of 10 to 20%.

A shrinkability can be measured according to thermal shrinkability A method defined in JIS Z 1712 (providing that the modified method is different from JIS Z 1712 in that a heating temperature adopted is 140° C. instead of 120° C. and a load of 3 g is imposed to a test piece). To be concrete, 5 test pieces with a width of 20 mm and a length of 150 mm are sampled in each of two directions, longitudinal (MD) and width (TD), and standard marks are attached on a surface of each of the test pieces with a distance of about 100 mm in the middle portion to thereby complete preparation for the test pieces. The test pieces were vertically hanged and heated in an air circulating constant temperature oven held at a temperature of 140° C.±3° C. for 15 min under a constant load of 3 g imposed thereon and thereafter, taken out and left at a standard temperature (room temperature) for 30 min, followed by measurement of standard distances with a calipers defined in JIS B 7507 to thereby obtain the average of the five measured values and to calculate S(MD) and D(TD) using an equation of S=[<standard distance (mm) before the heating−standard distance (mm) after the heating>/standard distance (mm) before the heating]×100.

A shrinkable film has preferably a difference between a shrinkability in the transverse direction and that in the machine direction: ΔS=S(TD)−S(MD) in the range of 0.5% ≦ΔS≦10%. More preferable is in the range of 1%≦ΔS≦10%. Especially preferable is in the range of 2%≦ΔS≦10%. The most preferable is in the range of 6%≦ΔS≦10%. If a shrinkability in the MD direction is large, a shrinkage force of the shrinkable film in addition to a stretch tension acts on a stretching machine, which makes uniformity in stretching difficult. A shrinkable film with parameters in the range does not impose an excessive load on the facility such as a stretching machine, thereby enabling uniform stretching to be conducted.

A preferable thickness range of a shrinkable film can be selected depending on a shrinkage force, a retardation of a design and the like, while, for example, a thickness of a shrinkable film is preferably in the range of from 10 to 500 μm and more preferably in the range of from 20 to 300 μm. Especially preferable is in the range of 30 to 100 μm. The most preferable is in the range of from 40 to 80 μm. A thickness in the above ranges ensures a sufficient shrinkability and enables a retardation film having an good optical uniformity to be prepared.

Adhesion of a shrinkable film to a polymer film is conducted so that a shrinkage direction of the shrinkable film includes at least a component of a direction perpendicular to the stretch direction. That is, all or part of a shrinkage force of the shrinkable film acts in a direction perpendicular to the stretch direction of the polymer film. Hence, the shrinkage direction of the shrinkable film may obliquely intersect with the stretch direction of the polymer film and no need arises for the shrinkage direction to be perfectly perpendicular to the stretch direction.

No limitation is imposed on a way of adhesion of a shrinkable film, but preferable is a method in which a pressure sensitive adhesive layer is inserted between a polymer film and a shrinkable film, resulting in adhesion to each other because of easiness in fabrication. The pressure sensitive adhesive layer can be formed on one or both of the polymer film and the shrinkable film. Since a shrinkable film is usually peeled off after fabrication of a retardation film, preferable is a pressure sensitive adhesive that is excellent in adherence and heat resistance in a heat stretching step, that can be peeled off with ease in a peeling-off step subsequent to the heat stretching step and that no pressure sensitive adhesive is remained on a surface of a retardation film. The pressure sensitive adhesive layer is preferably provided on a shrinkable film because of excellency in releasability.

Pressure sensitive adhesives constituting a pressure sensitive adhesive layer include acrylic based, synthetic rubber based, rubber based, silicone based and others. Preferable is an acrylic-based pressure sensitive adhesive having an acrylic-based polymer as a base polymer from the viewpoint of excellency in adherence, heat resistance and releasability. A weight average molecular weight (Mw) of the acrylic-based polymer calculated using a GPC method is preferably in the range of from 30,000 to 2,500,000 in terms of a polystyrene measured with the GPC method.

Various kinds of alkyl (meth)acrylate can be used as a monomer with which an acrylic-based polymer is constructed. Examples thereof include: (meth)acrylic acid alkyl ester (for example, alkyl ester having 1 to 20 carbon atoms such as methyl ester, ethyl ester, propyl ester, butyl ester, 2-ethylhexyl ester, isooctyl ester; isononyl ester, isodecyl ester; dodecyl ester, lauryl ester, tridecyl ester, pentadecyl ester; hexadecyl ester; heptadecyl ester, octadecyl ester, nonadecylester, eicosyl ester; and others), which can be used either alone or in combination.

In order to impart a polarity to an obtained acrylic-based polymer, the following monomers can be used as copolymerization monomer together with (meth)acrylic acid alkyl ester: carboxyl group-containing monomers such as (meth)acrylic acid and itaconic acid; hydroxyl group-containing monomers such as hydroxyethyl(meth)acrylate and hydroxyl propyl(meth)acrylate; amide group-containing monomers such as N-methylolacrylamide; cyano group-containing monomers such as (meth)acrylonitrile, epoxy group-containing monomers such as glycidyl(meth)acrylate; and vinyl esters such as vinyl acetate, styrene based monomers such as styrene and α-methylstyrene.

Note that no specific limitation is imposed on a polymerization method for an acrylic-based polymer and known polymerization methods can be adopted: such as solution polymerization, emulsion polymerization, suspension polymerization, UV polymerization.

A cross-linking agent can be incorporated into a pressure sensitive adhesive described above. Such cross-liking agents include: a polyisocyanate compound; a polyamine compound; melamine resin, urea resin; epoxy resin and the like. Besides, a tackifier, a plasticizer, a filler, an antioxidant, an ultraviolet absorbent, a silane coupling agent and the like can also be properly added to a pressure sensitive adhesive described above, when required.

No specific limitation is imposed on a method for forming a pressure sensitive adhesive layer and examples thereof include: a method (a transfer method) in which a pressure sensitive adhesive is coated on a release film, the wet coat is dried and thereafter, the dry coat is transferred onto a polymer film; a method (a direct transfer method) in which a pressure sensitive adhesive is coated directly on the polymer film and the wet coat is dried.

No specific limitation is imposed on a range of a preferable thickness of a pressure sensitive adhesive layer and the range thereof is properly determined depending on adhesive strength and a surface state of a retardation film. For example, a thickness thereof is preferably in the range of 1 to 100 μm and more preferably in the range of from 5 to 50 μm. Especially preferable is in the range of from 10 to 30 μm. A pressure sensitive adhesive layer with a thickness in the ranges can impart a sufficient shrinkability, thereby enabling a retardation film having good optical uniformity to be fabricated. A pressure sensitive adhesive layer described above can also be used in a way such that layers with different compositions or layers with different kinds are laminated. For a purpose to control an adhesive strength, a pressure sensitive adhesive layer can be added with a proper additive or additives such as a natural product including a tackifier resin, synthetic resins and an antioxidant, when required.

An exposed surface of a pressure sensitive adhesive layer is covered by temporarily attaching a release paper or a release film (also referred to as a separator) in a period till the layer is actually used in order to prevent contamination or the like. With such coverage applied, it can be prevented for a pressure sensitive adhesive layer to be brought into contact with something in a common handling. Examples of separators that can be used include: materials obtained in a procedure in which a proper thin, leaf-like material such as a plastic film, a rubber sheet, paper, a cloth, a nonwoven fabric, a net, a foamed sheet and a metal foil, and a laminate thereof is coated with a proper release agent such as silicone-based, a long-chain alkyl type, a fluorine containing type and molybdenum sulfide, which have been conventionally adopted, when required.

No specific limitation is imposed on an adhesive strength at the interface between a polymer film and a pressure sensitive adhesive layer at 23°, but an adhesive strength there is preferably in the range of from 0.1 to 10 N/50 mm. More preferable is in the range of from 0.1 to 5 N/50 mm. Especially preferable is in the range of from 0.2 to 3 N/50 mm. The adhesive strength can be measured in a way such that a shrinkable film is compressed by placing a shrinkable film on a polymer film to apply a manually operated roller according to JIS Z 0237 while being reciprocated three times, the composite film is subjected to an autoclave treatment (at 50° C. for 15 min at a pressure of 5 kg/cm²) as a an adhesive strength measuring sample and thereafter, the sample film is subjected to a 90 degree peel test according to JIS Z 0237 (a pulling speed is 300 mm/min) with a device according to JIS B 7721. In order to acquire an adhesive strength in the ranges, various methods can be applied: for example, a method in which a proper surface treatment such as a corona treatment, a plasma treatment or the like is applied to a surface on the side of a plastic film on which a pressure sensitive adhesive layer is provided to thereby adjust an adhesive strength to the pressure sensitive adhesive layer, and a method in which a composite film in a state where a polymer film and a shrinkable film are adhered to each other is subjected to a proper treatment such as a heat treatment or an autoclave treatment to thereby adjust an adhesive strength, which can be applied either alone or in combination.

One or more shrinkable films can be adhered to one or both surfaces of a polymer film in proper number thereof according to a shrinkage force of a design, but in cases where shrinkable films are adhered on both surfaces or plural shrinkable films are adhered to one surface of the polymer film, shrinkability of shrinkable films may be same or can vary at the front or rear thereof or in an upper portion or a lower portion thereof.

No specific limitation is imposed on a method for heat stretching of the invention, and any of conventionally known stretch treatment methods can be used as far as it is a method with which a tension in the stretch direction of a polymer film and a shrinkage force in a direction perpendicular to the stretch direction thereof can be imparted. Examples thereof include: a longitudinal uniaxial stretching method, a lateral uniaxial stretching method, a simultaneous longitudinal and lateral biaxial stretching method, an alternate longitudinal and lateral biaxial stretching method and the like. The stretch treatment method can be conducted using a proper stretching machine such as a roll stretching machine, a tenter and a biaxial stretching machine. The heat stretching may also be conducted in two, or three or more steps and a direction in which a polymer film is stretched may be either the film machine direction (MD direction) or the transverse direction (TD direction). A stretch direction can also be an oblique direction using a stretching method described in FIG. 1 of JP-A No. 2003-262721.

A temperature (also referred to as a stretch temperature) at which a retardation film is heat-stretched is preferably a glass transition temperature (Tg) of a polymer film or higher since a retardation value of the retardation film is easily uniform and the film is hard to crystallize or clouded. A stretch temperature is preferably in the range of from Tg of the polymer film +1° C. to Tg thereof +30° C. More preferable is in the range of from Tg +2° C. to Tg +20° C. More preferable is in the range of from Tg +3° C. to Tg +15° C. Especially preferable is in the range of from Tg +5° C. to Tg +10° C. A stretch temperature in the ranges enables uniform heat stretching to be performed. A stretch temperature being constant in the film transverse direction enables a retardation film small in variation of retardation value and having a good optical uniformity to be fabricated.

No specific limitation is imposed on a concrete method for maintaining a stretch temperature at a constant value and methods therefore include: a heater using a hot air and a cold air, or a microwave or infrared; known methods for heating or cooling and a temperature control method, using rolls, heat pipe rolls or a metal belt, heated or cooled, for temperature adjustment.

If a variation in a stretch temperature is large, non-uniformity in stretching increases, leading to a variation in retardation value of an eventually obtained retardation film. Hence, a smaller variation in temperature in the film transverse direction is preferable and more preferable is a variation in temperature in an in-plane direction of ±1° C. or less and especially preferable is a variation of a value less than ±1° C.

A stretch ratio in heat stretching is determined by a kind of a polymer used, a volatile component or the like, a residual amount of a volatile component, a retardation value of a design and therefore, no specific limitation is imposed on the stretch ratio, while preferable is, for example, in the range of 1.01 to 3. More preferable is in the range of from 1.1 to 2.5. Especially preferable is in the range of from 1.1 to 2. The most preferable is in the range of from 1.2 to 1.8. No specific limitation is imposed on a feed rate during stretching, a feed rate is preferably 0.5 m/min or more and more preferably 1 m/min or more from a viewpoint of machine accuracy and stability of a stretching machine.

As liquid crystalline polymers used for retardation firms, for example, various kinds of principal chain type or side chain type polymers may be mentioned in which conjugated linear atomic groups (mesogen) demonstrating liquid crystal alignment property are introduced into a principal chain and a side chain of the polymer. As illustrative examples of principal chain type liquid crystalline polymers, for example, nematic orientated polyester based liquid crystalline polymers having a structure where mesogenic group is bonded by a spacer section giving flexibility, discotic polymers, and cholesteric polymers, etc. may be mentioned. As illustrative examples of side chain type liquid crystalline polymers, there may be mentioned a polymer having polysiloxanes, polyacrylates, polymethacrylates, or poly malonates as a principal chain skeleton, and having a mesogen section including a para-substituted cyclic compound unit giving nematic orientation through a spacer section comprising conjugated atomic group as side chain. As preferable examples of oriented films obtained from these liquid crystalline polymers, there may be mentioned a film whose surface of a thin film made of polyimide or polyvinyl alcohol etc. formed on a glass plate is treated by rubbing, and a film obtained in a method that a solution of a liquid crystalline polymer is applied on an oriented surface of a film having silicon oxide layer vapor-deposited by an oblique vapor deposition method and subsequently the film is heat-treated to give orientation of the liquid crystal polymer, and among them, a film given tilted orientation is especially preferable.

A laminating method for the above-mentioned retardation films and polarizing plates is not especially limited, and lamination may be carried out using pressure sensitive adhesive layers etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

In addition, ultraviolet absorbing property may be given to the above-mentioned each layer, such as an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention is suitably used for a liquid crystal display in IPS mode. A liquid crystal display in IPS mode has a liquid crystal cell comprising: a pair of substrates sandwiching a liquid crystal layer; a group of electrodes formed on one of the above-mentioned pair of substrates; a liquid crystal composition material layer having dielectric anisotropy sandwiched between the above-mentioned substrates; an orientation controlling layer that is formed on each of surfaces, facing each other, of the above-mentioned pair of substrates in order to orient molecules of the above-mentioned liquid crystal composition material in a predetermined direction, and driving means for applying driver voltage to the above-mentioned group of electrodes. The above-mentioned group of electrodes has alignment structure arranged so that parallel electric field may mainly be applied to an interface to the above-mentioned orientation controlling layer and the above-mentioned liquid crystal composition material layer.

An optical film 3 of the invention is, as shown in FIGS. 2 and 3, disposed on the viewing side or the light incidence side of a liquid crystal cell 4. In the optical film of FIGS. 2 and 3, there are illustrated a case where the absorption axis of a polarizing plate 1 and the slow axis of a retardation film 2 are in parallel with each other, while both axes may be perpendicular to each other. The optical film 3 has the retardation film 2 side facing the liquid crystal cell 4. Though not shown in FIGS. 2 and 3, in a case where the optical film 3 of FIG. 1 is used in FIGS. 2 and 3, the transparent protective film 1b having retardation in the thickness direction (Rth) that has been adjusted to a smaller value in the thickness direction is closer to the liquid crystal cell 4 side than the transparent protective film 1b′. An another polarizing plate 1 is placed on the other side of the liquid crystal cell 4 opposite to the optical film 3. The absorption axis of another polarizing plate 1 and the absorption axis of the optical film 3 (the polarizing plate 1) are disposed on both sides, respectively, in a state of being perpendicular to each other. The another polarizing plate 1 that is used has the structure in which the transparent protective film 1b is laminated at least on one surface of the polarizer 1a similar to that used in the optical film 3 (when required, the transparent protective film 1b′is laminated on the other surface thereof). Another polarizing plate 1 is disposed so that the transparent protective film 1b faces the liquid crystal cell 4 side. Though not shown in FIGS. 2 and 3, in a case where the optical film 3 of FIG. 1 is used in FIGS. 2 and 3, the transparent protective film 1b having retardation in the thickness direction (Rth) that has been adjusted to a smaller value in the thickness direction is closer to the liquid crystal cell 4 side than the transparent protective film 1b′.

In the case where the optical film 3 is, as shown in FIG. 2, disposed on the viewing side of the liquid cell 4 in IPS mode, it is preferable to dispose a polarizing plate 1 on the substrate of the liquid crystal cell 4 on the other side (light incidence side) thereof from the viewing side so that an extraordinary index direction of a liquid crystal material in the liquid crystal cell 4 when no voltage is applied and the absorption axis of the polarizing plate 1 therein are in parallel to each other.

In the case where the optical film 3 is, as shown in FIG. 3, disposed on the light incidence side of the liquid cell 4 in IPS mode, it is preferable to dispose a polarizing plate 1 on the substrate of the liquid crystal cell 4 on the viewing thereof so that an extraordinary index direction of a liquid crystal material in the liquid crystal cell 4 when no voltage is applied and the absorption axis of the polarizing plate 1 in the optical film 3 are perpendicular to each other.

The above-mentioned optical film and polarizing plate may be used in a state where other optical films are laminated thereto on the occasion of practical use. The optical films used here are not especially limited, and, for example, one layer or two or more layers of optical films that may be used for formation of liquid crystal displays, such as reflectors, transflective, and retardation plates (including half wavelength plates and quarter wavelength plates etc.) may be used. Especially preferable polarizing plates are; a reflection type polarizing plate or a transflective type polarizing plate in which a reflector or a transflective reflector is further laminated onto a polarizing plate of the present invention; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The polarizing plate on which the retardation plate is laminated may be used as elliptically polarizing plate or circularly polarizing plate. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy (D-BEF and others manufactured by 3M Co., Ltd.); an oriented film of cholesteric liquid-crystal polymer; a film that has the characteristics of reflecting a circularly polarized light with either left-handed or right-handed rotation and transmitting other light, such as a film on which the oriented cholesteric liquid crystal layer is supported (PCF350 manufactured by Nitto Denko CORPORATION, Transmax manufactured by Merck Co., Ltd., and others); etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although optical films and polarizing plates having the above-mentioned optical films laminated thereto may be formed using methods in which they are laminated sequentially and separately in a manufacturing process of liquid crystal displays, films that are beforehand laminated and constituted as an optical film are superior in stability of quality, assembly work, etc., thus leading to advantages of improved manufacturing processes for liquid crystal displays. Suitable adhering means, such as adhesive layer, may be used for lamination for layers. In adhesion of the above-mentioned polarizing plate and other optical films, the optical axes may be arranged so that they have proper arrangement angles based on desired retardation characteristics etc.

Formation of a liquid crystal display may be carried out according to conventional methods. A liquid crystal display is generally formed using methods in which component parts, such as lighting systems, are suitably assembled, and driving circuits are subsequently incorporated, if necessary, and the present invention is not especially limited except that the above-mentioned optical film is used, and any methods according to conventional methods may be adopted. Also in liquid crystal cells, for example, liquid crystal cells of arbitrary type, such as VA type and π type, other than IPS mode type illustrated above may be used.

As liquid crystal displays, suitable liquid crystal displays, such as types using lighting systems or reflectors, may be formed. Furthermore, on the occasion of formation of liquid crystal displays, one layer of two or more layers of suitable parts, such as diffusion plates, anti-glare layer coatings, protective plates, prism arrays, lens array sheets, optical diffusion plates, and backlights, may be arranged in suitable position.

### EXAMPLE

While description will be given of the invention in a concrete manner with examples, it should be noted that the invention is not limited by description in the examples.

Refractive indices nx, ny and nz of a transparent protective film at 590 nm were measured with an automatic birefringence analyzer KOBRA-21ADH, manufactured by Oji Scientific Instruments and thereafter, an in-plane retardation Re and a thickness direction retardation Rth, Nz and an in-plane retardation Re were calculated.

### Example 1

(Transparent Protective Film)

Cyclopentanone is coated on a polyethylene terephthalate file and thereafter, the coated film was adhered to a triacetyl cellulose film with a thickness of 40 μm (with a trade name UZ-TAC manufactured by Fuji Photo Film Co., Ltd. having Re (590)=3 nm and Rth (590)=40 nm). The composite film was dried at 100° C. for 5 min after adhesion. The ethylene terephthalate film was peeled off after drying. The obtained transparent film (cellulose-based film) had Re (290)=0.2 nm and Rth (590)=5.4 nm.

(Polarizing Plate)

The above transparent protective films are laminated on both sides of a film (polarizer: 20 μm),obtained by dyeing a polyvinyl alcohol-based film with iodine to adsorb on thereof and stretching the polyvinyl alcohol-based film, with an adhesive to prepare a polarizing plate.

(Optical Film)

Shrinkable films each constituted of a biaxially stretched polyester film were adhered to both surfaces of a polycarbonate film (with a thickness of 68 μm) using an acrylic-based pressure sensitive adhesive and the composite film was stretched to a ratio of 1.03 at 130° C. to obtain a retardation film with a thickness of 65 μm, Re(590)=260 nm and Nz=0.5. The retardation film and the polarizing plate are laminated one on the other with a pressure sensitive adhesive so that the slow axis of the retardation film and the absorption axis of the polarizing plate are in parallel with each other to thereby fabricate an optical film.

(Liquid Crystal Display)

The optical film is laminated on the liquid crystal cell in the IPS mode with a pressure sensitive adhesive so that the retardation film side of the optical film faces the viewing side of the liquid cell in the IPS mode, as shown in FIG. 2. On the other hand, the polarizing plate was laminated on a surface on the other side of the liquid crystal cell from the viewing side thereof with a pressure sensitive adhesive to thereby fabricate the liquid crystal display. The polarizing plate on the viewing side is laminated so that an extraordinary ray refractive index direction of a liquid crystal composition in the liquid crystal cell and the absorption axis of the polarizing plate are perpendicular to each other, when no voltage is applied. Furthermore, arrangement was adopted so that the absorption axis of the polarizing plate and the absorption axis of the optical film are perpendicular to each other.

(Evaluation)

As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 50. Measurement of the contrast ratio was conducted using EZ Contrast (manufactured by ELDIM).

### Example 2

(Transparent Protective Film)

Norbornene-based resin was dissolved into cyclopentanone to prepare a solution with a solid matter of 20 wt %. The solution was coated on a triacetyl cellulose film with a thickness of 40 μm (with a trade name UZ-TAC manufactured by Fuji Photo Film Co., Ltd. having Re (590)=3 nm and Rth (590)=40 nm) to a thickness of 150 μm and thereafter the wet coat was dried at 140° C. for 3 min. After drying, the norbornene-based resin film formed on a surface of the tryacetyl cellulose film was peeled off. The obtained transparent film (cellulose-based film) had Re(590)=1.1 nm and Rth(590)=3.4 nm.

A polarizing plate and an optical film were prepared in a similar way to that in Example 1 with the exception that in Example 1, the transparent protective film described above was used. Besides, a liquid crystal display was fabricated in a similar way as that in Example 1. As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 60.

### Example 3

(Transparent Protective Film)

A solution was prepared to dissolve 100 parts by weight of a fatty acid cellulose ester with a degree of substitution with acetic acid of 2.2 and a degree of substitution of propionic acid of 0.7 and 18 parts by weight of dibutyl phthalate as a plasticizer into 570 parts by weight of acetone, which is a solvent. The solution was coated on a stainless plate by means of a general casting method, the wet coat was dried, and the dry coat is peeled off from the stainless plate to obtain a transparent film (cellulose-based film) with a thickness of 80 μm. The obtained transparent film had Re(590)=3.1 nm and Rth(590)=3.1 nm. A degree of substitution of a fatty acid cellulose ester was a value measured with an ASTM-D-817-91 (a test method for cellulose acetate or the like).

(Retardation Film)

Shrinkable films each constituted of a biaxially stretched polyester film were adhered on both surfaces of a norbornene-based film (with a thickness of 60 μm) with an acrylic-based pressure sensitive adhesive and the composite film was stretched at 146° C. to a stretch ratio of 1.38 to thereby obtain a retardation film having a thickness of 65 μm, Re(590)=260 nm and Nz=0.5.

A polarizing plate and an optical film were prepared in a similar way to that in Example 1 with the exception that in Example 1, the transparent protective film and the retardation film described above were used. Besides, a liquid crystal display was fabricated in a similar way as that in Example 1. As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 65.

### Example 4

(Transparent Protective Film)

Triacetyl cellulose resin (with a degree of substitution with acetic acid of 2.7) and p-toluene sulfonanilide as a plasticizer were mixed in proportion of 88:12 (in weight ratio) and the mixture was dissolved into methylene chloride to prepare a solution. The solution is coated on a stainless plate by means of the general casting method, the wet coat is dried and thereafter the dry coat is peeled off from the stainless plate to thereby obtain a transparent film (cellulose-based film) with a thickness of 80 μm. The obtained transparent film had Re(590)=0.5 nm and Rth(590)=1.1 nm.

Shrinkable films each constituted of a biaxially stretched polyester film were adhered on both surfaces of a norbornene-based film (with a thickness of 60 μm) with an acrylic-based pressure sensitive adhesive and the composite film was stretched at 146° C. to a stretch ratio of 1.38 to thereby obtain a retardation film having a thickness of 65 μm, Re(590)=260 nm and Nz=0.5.

A polarizing plate and an optical film were prepared in a similar way to that in Example 3 with the exception that in Example 3, the transparent protective film described above was used. Besides, a liquid crystal display was fabricated in a similar way as that in Example 1. As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 70.

### Comparative Example 1

(Polarizing Plate)

Triacetyl cellulose films each with a thickness of 40 μm (with a trade name UZ-TAC manufactured by Fuji Photo Film Co., Ltd. having Re (590)=3 nm and Rth (590)=40 nm) as transparent protective films are laminated with an adhesive on both sides of a film (polarizer: 20 μm), obtained by dyeing a polyvinyl alcohol-based film with iodine to adsorb on thereof and stretching the polyvinyl alcohol-based film, to prepare a polarizing plate.

The polarizing plates were laminated on both sides of a liquid cell in the IPS mode similar to that in Example 1 with a pressure sensitive adhesive to thereby fabricate a liquid crystal display. The polarizing plates were disposed on both sides of the liquid crystal cell so that the polarization axes are perpendicular to each other.

As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 9.

### Comparative Example 2

The polarizing plates used in Example 1 were laminated on both surfaces of a liquid crystal cell in the IPS mode similar to that in Example 1 with a pressure sensitive adhesive to fabricate a liquid crystal display. The polarizing plates were disposed on both surfaces of the liquid crystal cell so that the polarization axes are perpendicular to each other.

As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 6.

### Reference Example 1

Shrinkable films each constituted of a biaxially stretched polyester film were adhered on both surfaces of a polycarbonate film with an acrylic-based pressure sensitive adhesive, the composite film was stretched at 130° C. to a stretch ratio of 1.01 to obtain a retardation film with an in-plane retardation Re(590)=100 nm and Nz=0.5 and the retardation film was laminated on the polarizing plate fabricated in Example 1 using a pressure sensitive adhesive in a way such that the slow axis of the retardation film and the absorption axis of the polarizing plate are in parallel with each other to thereby fabricate a polarization optical film. The polarization optical film thus fabricated was laminated on a liquid crystal cell in the IPS mode with a pressure sensitive adhesive so that the retardation film side thereof, in a similar way to that in Example 1, faces the viewing side of the liquid crystal cell in the IPS mode. On the other hand, the polarizing plate used in Example 1 was laminated on a surface of the other side of the liquid crystal cell from the viewing side with a pressure sensitive adhesive to thereby fabricate a liquid crystal display.

As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 15.

### Comparative Example 3

A retardation film with an in-plane retardation Re(590)=260 nm and Nz=1.0 that was obtained by stretching a polycarbonate film was laminated on the polarizing plate that was fabricated in Example 1 using a pressure sensitive adhesive so that the slow axis of the retardation film and the absorption axis of the polarizing plate are in parallel with each other to thereby fabricate a polarization optical film. The polarization optical film thus fabricated were laminated on the liquid crystal cell in the IPS mode with a pressure sensitive adhesive so that the retardation film side thereof, in a similar way to that in Example 1, faces the viewing side of the liquid crystal cell in the IPS mode. On the other hand, the polarizing plate that was used in Example 1 was laminated on the other side of the liquid crystal cell in the IPS mode from the viewing side with a pressure sensitive adhesive to thereby fabricate a liquid crystal display.

As to the liquid crystal display, a contrast ratio was measured at an azimuth angle of 45 degrees relative to an optical axes perpendicular to each other of the polarizing plates and an inclination from a normal direction of 70 degrees to thereby obtain a contrast ratio of 7.

1. An optical film comprising a polarizing plate obtained by laminating a transparent protective film on at least one surface of a polarizer and a retardation film laminated on one surface of the polarizing plate so that the absorption axis of the polarizing plate and the slow axis of the retardation film are perpendicular to or in parallel with each other, wherein
the retardation film satisfies a relation of nx>nz>ny, and
the transparent protective film is disposed at least on the retardation film side and is a cellulose-based film with retardation in the thickness direction, which is expressed by (Rth)=(nx−nz)×d, in the range of 0 to 10 nm,
where in each of the films, a refractive index of a slow axis direction, a refractive index of a fast axis direction and a refractive index in the thickness direction at a wavelength of 590 nm are represented by nx, ny and nz, respectively, that a film thickness is represented d (nm) and that the slow axis direction is defined as a direction in which a refractive index in a film plane is maximized.

2. The optical film according to claim 1, wherein the retardation film satisfies that an Nz value, which is expressed by Nz=(nx−nz)/(nx−ny), is in the range of from 0.4 to 0.6 and
an in-plane retardation, which is expressed by (Re)=(nx−ny)×d, is in the range of from 200 to 350 nm.

3. An image viewing display comprising the optical film according to claim 1.

4. A liquid crystal display in the IPS mode, comprising a liquid crystal cell,
the optical film according to claim 1 disposed on a first cell substrate of the viewing side so that the retardation film faces the first cell substrate side, and
a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a second cell substrate on the other side relative to the viewing side so that the transparent protective film faces the second cell substrate side,
wherein, in a state where no voltage is applied, an extraordinary ray refractive index direction of a liquid crystal material in the liquid crystal cell and the absorption axis of the polarizing plate are in parallel with each other.

5. A liquid crystal display in the IPS mode, comprising a liquid crystal cell,
a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a first cell substrate on the viewing side so that the transparent protective film faces the first cell substrate side, and
the optical film according to claim 1 is disposed on the second cell substrate on the other side relative to the viewing side so that the retardation film in the optical film faces the second cell substrate side,
wherein, in a state where no voltage is applied, an extraordinary ray refractive index direction of a liquid crystal material in the liquid crystal cell and the absorption axis of the optical film are perpendicular to each other.

6. An image viewing display comprising the optical film according to claim 2.

7. A liquid crystal display in the IPS mode, comprising a liquid crystal cell,
the optical film according to claim 2 disposed on a first cell substrate of the viewing side so that the retardation film faces the first cell substrate side, and
a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a second cell substrate on the other side relative to the viewing side so that the transparent protective film faces the second cell substrate side,
wherein, in a state where no voltage is applied, an extraordinary ray refractive index direction of a liquid crystal material in the liquid crystal cell and the absorption axis of the polarizing plate are in parallel with each other.

8. A liquid crystal display in the IPS mode, comprising a liquid crystal cell,
a polarizing plate obtained by laminating a cellulose-based film having retardation in the thickness direction, which is expressed by (Rth)=(nx−nz)×d, in the range of from 0 to 10 nm, as a transparent protective film on at least one surface of a polarizer is disposed on a first cell substrate on the viewing side so that the transparent protective film faces the first cell substrate side, and
the optical film according to claim 2 is disposed on the second cell substrate on the other side relative to the viewing side so that the retardation film in the optical film faces the second cell substrate side,
wherein, in a state where no voltage is applied, an extraordinary ray refractive index direction of a liquid crystal material in the liquid crystal cell and the absorption axis of the optical film are perpendicular to each other.
